(19) United States
(12) Patent Application Publication
(10) Pub. No.: US 2024/0186841 A1
(43) Pub. Date: Jun. 6, 2024

(54) Magnetic Material, Iron Core, and Rotating Electric Machine

(71) Applicant: Hitachi, Ltd., Chiyoda-ku, Tokyo (JP)

(72) Inventors: Yusuke ASARI, Tokyo (JP); Tomohiro TABATA, Tokyo (JP); Shinya TAMURA, Tokyo (JP); Matahiro KOMURO, Tokyo (JP); Shohei TERADA, Tokyo (JP)

(21) Appl. No.: 18/287,723

(22) PCT Filed: Apr. 5, 2022
(86) PCT No.: PCT/JP2022/017115

§ 371 Date: Oct. 20, 2023

(30) Foreign Application Priority Data
Apr. 23, 2021 (JP) 2021-073529

(51) Int. Cl. H02K 1/02; H01F 1/16; H01F 27/245

(52) U.S. Cl. CPC H02K 1/02; H01F 1/16; H01F 27/245

(57) ABSTRACT

A magnetic material includes body-centered tetragonal (bct) crystal including iron and nitrogen, in which a molar ratio of iron to nitrogen in the crystal exceeds 8. An iron core includes soft magnetic steel sheets stacked together, in which a part or the entirety of the soft magnetic steel sheets is formed of the magnetic material which includes body-centered tetragonal (bct) crystal including iron and nitrogen and has a molar ratio of iron to nitrogen in the crystal exceeds 8. A rotating electric machine includes an iron core including soft magnetic steel sheets stacked together, in which a part or the entirety of the soft magnetic steel sheets is formed of the magnetic material which includes body-centered tetragonal (bct) crystal including iron and nitrogen and has a molar ratio of iron to nitrogen in the crystal exceeds 8.

### TECHNICAL FIELD

The present invention relates to an iron nitride magnetic material based on α″-Fe₁₆N₂, and an iron core and a rotating electric machine formed of the same magnetic material.

### BACKGROUND ART

As an alloy having a higher saturation magnetic flux density Bs than pure iron, an iron-cobalt-based alloy is known. The Bs of pure iron is 2.14 T at 20° C.

For example, Permendur of Fe-49Co-2V has Bs of 2.3 T as a bulk and is widely used as a soft magnetic material having high Bs for an iron core of a motor or the like. However, the iron-cobalt-based alloy includes cobalt that is more expensive than iron, and thus has problems in mass productivity or costs.

Recently, as a magnetic material that is more economical than the iron-cobalt-based alloy and has a higher saturation magnetic flux density Bs than pure iron, iron nitride α″-Fe₁₆N₂ has attracted attention. α″-Fe₁₆N₂ is an iron-based martensite having a body-centered tetragonal (bct) structure, and has a crystal structure where N penetrates into α-Fe such that the lattice spacing is expanded in a c-axis direction.

The iron nitride α″-Fe₁₆N₂ is a metastable phase, has low thermal stability, and thus is known to be difficult to grow crystals. In the related art, regarding α″-Fe₁₆N₂, various research and development activities including a manufacturing method have been carried out.

PTL 1 describes a magnetic multilayer film where a film including a ferromagnetic element and a nonmagnetic material having a spacing that has a matching relationship with a spacing of the film including a ferromagnetic element are alternately epitaxially grown and stacked. The film including a ferromagnetic element is a Fe-N binary film or a Fe—Co—N ternary film, and is formed of a material based on α″-Fe₁₆N₂.

PTL 2 describes a manufacturing method capable of forming an iron nitride film having high saturation magnetization and low coercive force with high speed and stability. α″-Fe₁₆N₂ has a stacked structure of α-Fe by reactive sputtering using N₂ gas. PTL 2 also describes that a molar ratio between iron and nitrogen changes during nitriding heat treatment.

### CITATION LIST

### Patent Literature

PTL 1: JPH06-020834A
PTL 2: WO1996/02925A

### SUMMARY OF INVENTION

### Technical Problem

For various uses such as a rotating electric machine or a transformer, a soft magnetic material that is economical and has a high saturation magnetic flux density Bs is required. For the use of an iron core, a conversion efficiency between magnetic energy and electric energy is important, and it is desired to simultaneously achieve high saturation magnetic flux density Bs and low iron loss Pi. In PTLs 1 and 2, the magnetic film having a stacked structure is formed to form α″-Fe₁₆N₂ having high Bs and low thermal stability.

However, in α″-Fe₁₆N₂ in the related art, a high saturation magnetic flux density Bs that is comparable to a theoretically calculated value cannot be obtained. Currently, for various uses, a high Bs that exceeds the theoretically calculated value of α″-Fe₁₆N₂ is desired. However, a method of increasing the Bs of α″-Fe₁₆N₂ from that in the related art is not known.

Accordingly, an object of the invention is to provide a magnetic material with which a higher saturation magnetic flux density than iron nitride α″-Fe₁₆N₂ can be obtained, and an iron core and a rotating electric machine formed of the same magnetic material.

### Solution to Problem

To achieve the object, according to the invention, there is provided a magnetic material including body-centered tetragonal (bct) crystal including iron and nitrogen, in which a molar ratio of iron to nitrogen in the crystal exceeds 8. According to the invention, there is provided an iron core where soft magnetic steel sheets are stacked, in which a part or the entirety of the soft magnetic steel sheets is formed of the magnetic material. According to the invention, there is provided a rotating electric machine including an iron core where soft magnetic steel sheets are stacked, in which a part or the entirety of the soft magnetic steel sheets is formed of the magnetic material.

### Advantageous Effects of Invention

The invention can provide a magnetic material with which a higher saturation magnetic flux density than iron nitride α″-Fe₁₆N₂ can be obtained, and an iron core and a rotating electric machine formed of the same magnetic material.

### BRIEF DESCRIPTION OF DRAWINGS

FIG. 1 is a diagram illustrating a crystal structure of iron nitride α″-Fe₁₆N₂.

FIG. 2 is a diagram illustrating a crystal structure model where nitrogen defects are introduced into the iron nitride α″-Fe₁₆N₂.

FIG. 3 is a diagram illustrating a calculated value of saturation magnetic flux density with respect to an introduction amount of nitrogen defects.

FIG. 4 is a perspective view schematically illustrating an example of a stator of a rotating electric machine.

FIG. 5 is an enlarged cross-sectional view schematically illustrating a slot region of the stator.

FIG. 6 is a diagram illustrating a calculation model used for calculating an electronic structure.

### DESCRIPTION OF EMBODIMENTS

Hereinafter, a magnetic material according to one embodiment of the invention and an iron core and a rotating electric machine formed of the same magnetic material will be described with reference to the drawings. In each of the following drawings, common configurations are represented by the same reference numerals, and the description thereof will not be repeated.

### <Magnetic Material>

The magnetic material according to the embodiment is a magnetic material including iron (Fe) and nitrogen (N), is ferromagnetic at room temperature, and includes body-centered tetragonal (bct) crystal including iron and nitrogen based on iron nitride α″-Fe₁₆N₂. The magnetic material has a bct crystal structure where nitrogen defects are introduced into iron nitride α″-Fe₁₆N₂ having a bct structure or into a heterogeneous element-substituted product obtained by adding a substitutional solid solution heterogeneous element to the iron nitride. Due to the introduction of the nitrogen defects, a molar ratio of iron to nitrogen in the crystal having a bct structure exceeds 8.

Here, the object, the mechanism, or the like of the introduction of nitrogen defects into the iron nitride α″-Fe₁₆N₂ will be described.

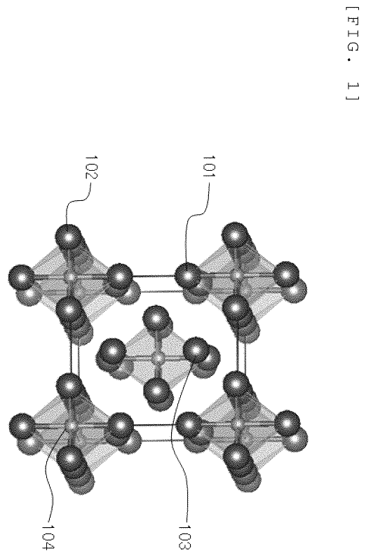

FIG. 1 is a diagram illustrating a crystal structure of the iron nitride α″-Fe₁₆N₂.

FIG. 1 illustrates a unit lattice of the iron nitride α″-Fe₁₆N₂. In FIG. 1, reference numeral 101 represents a 4e site occupied by an iron atom. Reference numeral 102 represents an 8h site occupied by an iron atom. Reference numeral 103 represents a 4d site occupied by an iron atom. Reference numeral 104 represents a 2a site occupied by a nitrogen atom.

As illustrated in FIG. 1, the unit lattice of the iron nitride α″-Fe₁₆N₂ includes 16 iron atoms and 2 nitrogen atoms. The iron atoms and the nitrogen atoms are regularly arranged. The crystal structure of α″-Fe₁₆N₂ is body-centered tetragonal (bct) and belongs to a space group I4/mmm. As literature values that are experimentally obtained, the lattice constant of the a-axis is 5.72 Å, and the lattice constant of the c-axis is 6.29 Å.

In the unit lattice, iron atoms occupy three types of crystallographic sites that are independent of each other. The iron atoms of the 4e site (101) and the 8h site (102) bind to the nitrogen atom in the 2a site (104). On the other hand, the iron atom in the 4d site (103) does not bind to the nitrogen atom in the 2a site (104). The iron atom in the 4d site (103) is coordinated in the crystal structure as in a body-centered cubic (bcc) structure.

The iron nitride α″-Fe₁₆N₂ is known as a soft magnetic material having a high saturation magnetic flux density Bs. The reason why the α″-Fe₁₆N₂ has high Bs is discussed based on a theoretical study. The magnetism of a bulk material is represented well by first principle calculation using a density-functional theory. The magnetic moments of the iron atoms of the α″-Fe₁₆N₂ can be analyzed mainly using a first principle density functional theory.

The magnetic moment is a vector quantity representing the size of a magnetic force and a direction of a magnetic force. The magnetic moment is represented as a vector sum of the unique magnetic moment of a proton, the unique magnetic moment of electrons, and the magnetic moment of an orbital motion of electrons. The magnetic moment of a bulk material is determined mainly depending on a spin angular momentum of an unpaired electron. As the magnetic moment increases, a stronger magnetic force is exhibited.

The first principle density functional theory is a method of acquiring various physical properties including magnetic characteristics approximately in a range of the first principle using a function of an electron density. By minimizing the energy of the system based on the variational principle, the ground state of the system can be acquired. In the first principle calculation, an experimental parameter is not used. Therefore, the reliability is high, and information complementary to the information that is experimentally acquired is obtained.

According to the calculation using the first principle density functional theory, the average magnetic moment of the iron atoms of the iron nitride α″-Fe₁₆N₂ is 2.4μ_{B}. The average magnetic moment of iron atoms of pure iron is 2.2μ_{B}. The average magnetic moment of the iron atoms of the α″-Fe₁₆N₂ is more than that of pure iron by about 9%. The difference in magnetic moment brings about a high saturation magnetic flux density Bs of the α″-Fe₁₆N₂.

The inventors calculated the magnetic moment of the iron atom in each of the crystallographic sites in the iron nitride α″-Fe₁₆N₂ using the first principle density functional theory. As a result, the average magnetic moments of the iron atom were 2.18μ_{B} in the 4e site, 2.38μ_{B} in the 8h site, and 2.85μ_{B} in the 4d site, respectively. It was found that the iron atom in the 4d site not binding to a nitrogen atom had a specifically high magnetic moment as compared to the iron atom binding to the nitrogen atom.

The magnetic material according to the embodiment is based on such finding, and by introducing nitrogen defects into the iron nitride α″-Fe₁₆N₂ or into the heterogeneous element-substituted product thereof, the number of iron atoms not binding to a nitrogen atom increases to improve the saturation magnetic flux density Bs. The introduction of the nitrogen defects represents atomic vacancy where the bct 2a site is vacant. It is expected that, when the nitrogen defects are introduced, the number of iron atoms not binding to a nitrogen atom in the 4e site and 8h site increases, and the magnetic characteristics thereof were analyzed as follows.

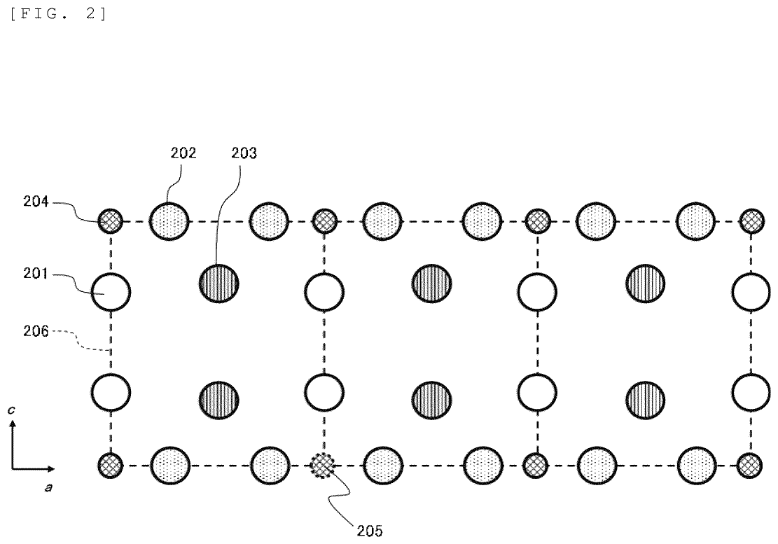

FIG. 2 is a diagram illustrating a crystal structure model where nitrogen defects are introduced into the iron nitride α″-Fe₁₆N₂.

In FIG. 2, reference numeral 201 represents a 4e site occupied by an iron atom. Reference numeral 202 represents an 8h site occupied by an iron atom. Reference numeral 203 represents a 4d site occupied by an iron atom. Reference numeral 204 represents a 2a site occupied by a nitrogen atom. Reference numeral 205 represents atomic vacancy. Reference numeral 206 represents a boundary between unit cells of crystal.

As illustrated in FIG. 2, the crystal structure model where nitrogen defects are introduced into the iron nitride α″-Fe₁₆N₂ was generated, and the magnetic moment of the iron atom positioned at each of the crystallographic sites was calculated using the first principle density functional theory. As the crystal structure model, 9 types represented by Fe₁₆N₂₋ₓ where x=0, 0.125, 0.25, 0.5, 0.75, 1.0, 1.25, 1.5, and 1.75 were analyzed. The atomic vacancies (205) were regularly arranged and introduced at intervals.

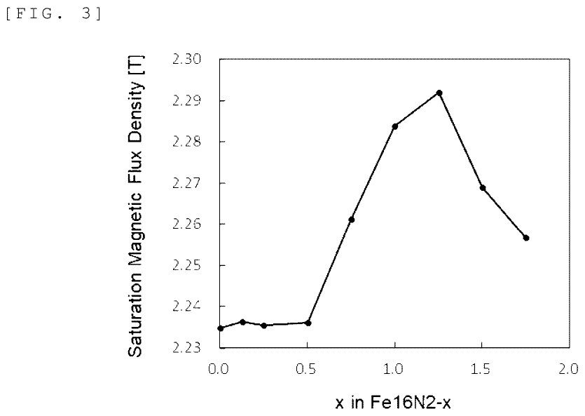

FIG. 3 is a diagram illustrating a calculated value of saturation magnetic flux density with respect to the introduction amount of nitrogen defects.

As illustrated in FIG. 3, when nitrogen defects were not introduced (x=0), the average magnetic moment of iron atoms was 2.235μ_{B}. When the introduction amount of nitrogen defects to all of the 2a sites was increased from 0% (x=0) to 25% (x=0.5), the average magnetic moment of the iron atoms gradually increased in proportion to the introduction amount of the nitrogen defects, but the increase was small.

When the introduction amount of the nitrogen defects was increased to 25% (x=0.5) or more, the average magnetic moment of the iron atoms rapidly increased in proportion to the introduction amount of the nitrogen defects. When the introduction amount was 62.5% (x=1.25), the average magnetic moment was 2.29μ_{B} as a maximum value. When the introduction amount further increased, the average magnetic moment started to decrease in inverse proportion to the introduction amount. When the introduction amount was 75% (x=1.5), the average magnetic moment was about 2.27μ_{B}. When the introduction amount was 87.5% (x=1.75), the average magnetic moment was about 2.256μ_{B}.

It was verified from the result that, when the introduction amount of the nitrogen defects with respect to the stoichiometric ratio of nitrogen is 25 to 75 at % (0.5≤x≤1.5), a particularly high average magnetic moment can be obtained such that the saturation magnetic flux density Bs is likely to be improved as compared to iron nitride α″-Fe₁₆N₂ of perfect crystal. That is, it was found that, when the molar ratio of iron to nitrogen in the body-centered tetragonal (bct) crystal exceeds 8, the saturation magnetic flux density Bs is improved. The molar ratio of iron to nitrogen in the body-centered tetragonal (bct) crystal is preferably 32 or less.

In the related art, regarding the iron nitride α″-Fe₁₆N₂, the reason why the magnetic moment of an iron atom not adjacent to a nitrogen atom is high is described based on band calculation (Akimasa SAKUMA, “electronic structure and magnetic structure of nitride magnetic body”, the Japan Institute of Metals (1992), Vol. 31, Issue 11, pp. 999-1007).

According to the band calculation, the 3d level of an iron atom binding to a nitrogen atom is shifted to the low energy side, and thus the 3d level of an iron atom adjacent thereto is shifted to the high energy side. As a result, into an iron atom binding to a nitrogen atom, electrons flow from an iron atom adjacent thereto, and the magnetic moment of the iron atom binding to the nitrogen atom decreases. On the other hand, the magnetic moment of the adjacent iron atom increases.

Considering the movement of the electron, the reason why the magnetic moment increases when nitrogen defects are introduced is considered to be as follows.

When nitrogen defects are introduced into the iron nitride α″-Fe₁₆N₂, the number of iron atoms binding to a nitrogen atom decreases. An iron atom adjacent to the 2a site where nitrogen defects are introduced is the second nearest iron atom that is coordinated next to the iron atom adjacent to the nitrogen atom when seen from another iron atom binding to the nitrogen atom. The second nearest iron atom is not binding to the nitrogen atom.

When nitrogen defects are not introduced, the second nearest site is only the 4d site. However, when nitrogen defects are introduced, the 8h site or the 4e site is also the second nearest site. Electron flow occurs from the iron atom in the second nearest site to the iron atom binding to the nitrogen atom. As a result, it is considered that the magnetic moment of the second nearest iron atom is high.

Note that when the introduction amount of the nitrogen defects is excessively large, nitrogen is rare in the crystal structure, and most of the second nearest sites to the iron atom become atomic vacancies. When there are too many atomic vacancies, the structure becomes closer to body-centered cubic (bcc) as in α-Fe. It is considered that, since the average magnetic moment of iron atoms of α-Fe is low at 2.2μ_{B}, the saturation magnetic flux density Bs is improved as compared to the iron nitride α″-Fe₁₆N₂.

Next, regarding the magnetic material including the body-centered tetragonal (bct) crystal that includes iron and nitrogen into which nitrogen defects are introduced, a more specific configuration will be described.

A part or the entirety of iron (Fe) in the body-centered tetragonal (bct) crystal into which nitrogen defects are introduced may be substituted with a metal element such as cobalt (Co) or nickel (Ni). As the element with which Fe is substituted, Co is preferable from the viewpoint of obtaining a high saturation magnetic flux density Bs.

From the viewpoint of cost reduction and the like, the Co content is preferably 25 at % or less and more preferably 20 at % or less. When Co is actively added, the Co content is preferably 1 at % or more, and more preferably 5 at % or more. The Ni content is preferably 3 at % or less. When Ni is actively added, the Ni content is preferably 0.01 at % or more. The Co content or the Ni content may be less than or equal to a substantial amount of unavoidable impurities.

A part of nitrogen (N) in the body-centered tetragonal (bct) crystal into which nitrogen defects are introduced may be substituted with a light element such as carbon (C), oxygen (O), or boron (B). As the element with which N is substituted, C is preferable from the viewpoint of obtaining a high magnetic moment. C stabilizes nonmagnetic γ phase and generates a low magnetic carbide. However, when N is substituted with an appropriate amount of C, the iron loss Pi can be reduced while the saturation magnetic flux density Bs is kept high.

The N content is less than 11.1 at %, and from the viewpoint of adjusting the introduction amount of nitrogen defects to be 25 to 75% (0.5≤x≤1.5), is preferably 2.8 at % or more and 8.3 at % or less. From the viewpoint of adjusting the introduction amount of nitrogen defects to be 37.5 to 75% (0.75≤x≤1.5), the N content is preferably 4.2 at % or more and 8.3 at % or less.

The C content is preferably 3 at % or less. When C is actively added, the C content is preferably 0.01 at % or more. The O content is preferably 3 at % or less. When O is actively added, the O content is preferably 0.01 at % or more. The B content is preferably 3 at % or less. When B is actively added, the B content is preferably 0.01 at % or more. The C content, the O content, or the B content may be less than or equal to a substantial amount of unavoidable impurities.

That is, the magnetic material according to the embodiment includes body-centered tetragonal (bct) crystal represented by the following Formula (I).

Fe_{16-a-b}CoₐNi_{b}N_{2-c-x}A_{c} (I)

[In Formula (I), A represents one or more elements selected from the group consisting of C, O, and B, and 0≤a<16, 0≤b<16, 0≤c<2, and 0<x<2 are satisfied.]

In Formula (I), the coefficient x representing nitrogen defects is preferably 0.5≤x≤1.5 and more preferably 0.75≤x≤1.5. When Co is actively added, the coefficient a is preferably 0.18≤a≤4.5 and more preferably 0.18≤a≤3.6. When Ni is actively added, the coefficient b is preferably 0.18≤b≤0.54. When C, O, or B is actively added, the coefficient c is preferably 0.18≤b≤0.54.

The lattice constant (c-axis length) of the c-axis of the body-centered tetragonal (bct) crystal into which nitrogen defects are introduced is preferably 5.66 Å or more and less than 6.23 Å as the average value per material. As the theoretically calculated value, the c-axis length of bct pure iron is 5.66 Å. The c-axis length of α″-Fe₁₆N₂ of perfect crystal is 6.23 Å. In the above-described range, nitrogen defects are appropriately introduced. Therefore, the high saturation magnetic flux density Bs per volume can be obtained. 1 Å is 0.1 nm.

The volume of the unit lattice of the body-centered tetragonal (bct) crystal into which nitrogen defects are introduced is preferably 181.3 Å³ or more and less than 201.2 Å³ as the average value per material. As the theoretically calculated value, the volume of the unit lattice of bct pure iron is 181.3 Å³. The volume of the unit lattice of α″-Fe₁₆N₂ of perfect crystal is 201.2 Å³. In the above-described range, nitrogen defects are appropriately introduced. Therefore, the high saturation magnetic flux density Bs per volume can be obtained.

The minimum distance between nitrogen atoms in the body-centered tetragonal (bct) crystal into which nitrogen defects are introduced is preferably 6.8 Å or more. When the molar ratio of iron to nitrogen is 16 (Fe₁₆N), the average distance between nitrogen atoms is 6.8 Å. In the above-described range, nitrogen defects are dispersively introduced. Therefore, the effect of improving the magnetic moment of the second nearest site of the nitrogen atom can be easily obtained over the entire crystal.

The volume fraction of the body-centered tetragonal (bct) crystal into which nitrogen defects are introduced is preferably 10 vol % or more, more preferably 30 vol % or more, still more preferably 50 vol % or more, still more preferably 70 vol % or more, and still more preferably 90 vol % or more with respect to 100 vol % of the magnetic material.

As long as bct crystal including iron and nitrogen is included, the magnetic material according to the embodiment may partially include one kind or more among α′ phase, γ phase, and γ′ phase of Fe₈N, ε phase of Fe₃N, and the like. Note that the volume fraction of nonmagnetic γ phase is 5 vol % or less. The volume fraction of γ′ phase having a low saturation magnetic flux density Bs is preferably 5 vol % or less. The volume fraction of ε phase having a low saturation magnetic flux density Bs is preferably 5 vol % or less.

In the magnetic material according to the embodiment, the body-centered tetragonal (bct) crystal into which nitrogen defects are introduced may or may not have a concentration gradient for the metal element with which Fe is substituted and the light element with which N is substituted.

The crystal structure of the magnetic material can be verified by X-ray diffraction (XRD) measurement. The chemical composition of the magnetic material can be verified using an electron probe micro analyzer (EPMA) and the like. Whether nitrogen defects are introduced can be verified by comparing the analysis result of the crystal structure and the analysis result of the chemical composition to those of α″-Fe₁₆N₂ of perfect crystal. The volume fraction of the crystal can be acquired by observing the structure with a scanning electron microscope (SEM) and the like, and analyzing the image.

### <Method of Manufacturing Magnetic Material>

The magnetic material according to the embodiment can be manufactured using a method of limiting the nitrogen content during the synthesis of the iron nitride α″-Fe₁₆N₂ or the heterogeneous element-substituted product thereof.

Examples of a method of synthesizing the iron nitride α″-Fe₁₆N₂ or the heterogeneous element-substituted product thereof include a method of performing a nitrogen penetration heat treatment on an iron-based material, a method of performing a nitrogen penetration heat treatment and a denitrifying heat treatment on an iron-based material, a physical vapor deposition method of limiting the nitrogen content, a sputtering method, a molecular beam epitaxy method, and an ion implantation method. Hereinafter, the method of manufacturing the magnetic material will be described using the method of performing a nitrogen penetration heat treatment on an iron-based material and the method of performing a nitrogen penetration heat treatment and a denitrifying heat treatment on an iron-based material as an example.

When the method of performing only the nitrogen penetration heat treatment is used, the magnetic material according to the embodiment can be obtained using a method including a material preparation step, a homogenization heat treatment step, a nitrogen penetration heat treatment step, and a cooling step in this order. When the method of performing the nitrogen penetration heat treatment and the denitrifying heat treatment is used, the magnetic material according to the embodiment can be obtained using a method including a material preparation step, a homogenization heat treatment step, a nitrogen penetration heat treatment step, a denitrifying heat treatment step, and a cooling step in this order.

### (Material Preparation Step)

The material preparation step is a step of preparing a starting material of the magnetic material. As the starting material, a material having a sheet shape, a foil shape, or the like is prepared. The thickness of the starting material can be, for example, 0.01 mm or more and 1 mm or less. As the starting material, an iron-based material including the metal element with which iron is substituted or including the light element with which nitrogen is substituted can be used. Examples of the iron-based material include pure iron, steel that is a low carbon and low alloy element, alloy steel, electromagnetic steel, and an iron-cobalt-based alloy.

In the starting material, the carbon content is preferably 1.5 mass % or less. In the starting material, the total content of alloy elements is preferably 5 mass % or less. The reason is that, when the content of carbon or alloy elements is high, low magnetic γ phase or the like remains after martensite transformation, and the saturation magnetic flux density Bs may decrease. When the carbon content is high, a carbide where nitrogen atoms are not likely to be dissolved is formed, which hinders highly uniform diffusion of nitrogen atoms.

### (Homogenization Heat Treatment Step)

The homogenization heat treatment step is a step of heating the starting material at an austenite formation temperature (Ac3 transformation point) or higher to homogenize the starting material. The homogenization heat treatment is performed in an inert gas atmosphere such as argon gas. For example, the starting material is heated at 900° C. or higher to diffuse chemical components in the material with high uniformity.

### (Nitrogen Penetration Heat Treatment Step)

The nitrogen penetration heat treatment step is a step of bringing nitrogen penetrating gas into contact with the material in the heat treatment to penetrate and diffuse nitrogen into the material. The nitrogen penetration heat treatment is preferably performed at a temperature higher than the eutectic temperature (A1 transformation point). The reason is that nitrogen is not likely to penetrate into the carbide Fe₃C or the like but is dissolved in γ phase or the like. For example, the material cooled with gas is heated to 700 to 900° C., and the nitrogen penetrating gas is supplied in an inert gas atmosphere. As the nitrogen penetrating gas, for example, ammonia can be used.

In the nitrogen penetration heat treatment step, to introduce nitrogen defects, the diffusion amount of nitrogen can be adjusted. Regarding nitrogen in the material, a concentration gradient may be or may not be formed. When the denitrifying heat treatment step is performed, in the nitrogen penetration heat treatment step, nitrogen may be diffused in an amount that is more than or equal to a substantial amount of the stoichiometric ratio without adjusting the diffusion amount of nitrogen.

The diffusion amount of nitrogen can be adjusted using a method of controlling the amount (partial pressure) of the nitrogen penetrating gas, a method of controlling an atmosphere pressure (total pressure) including the nitrogen penetrating gas, a method of controlling the temperature of the nitrogen penetration heat treatment, a method of controlling the time of the contact with the nitrogen penetrating gas, or a combination thereof. The introduction amount of nitrogen defects can be increased by a control of reducing the amount of the nitrogen penetrating gas, a control of lowering the atmosphere pressure, a control of lowering the temperature, or a control of reducing the time of the contact with nitrogen.

### (Denitrifying Heat Treatment Step)

The denitrifying heat treatment step is a step of emitting nitrogen from the material in the heat treatment to introduce nitrogen defects into the material. The denitrifying heat treatment step is performed when, in the nitrogen penetration heat treatment step, nitrogen is diffused in an amount that is more than or equal to a substantial amount of the stoichiometric ratio without adjusting the diffusion amount of nitrogen. The denitrifying heat treatment can be performed, for example, after heating the material to 700 to 900° C.

The emission amount of nitrogen can be adjusted using a method of controlling the amount (partial pressure) of the nitrogen penetrating gas, a method of controlling an atmosphere pressure (total pressure), a method of controlling the temperature of the denitrifying heat treatment, a method of controlling the time of the denitrifying heat treatment, or a combination thereof. The emission amount of nitrogen can be increased by a control of reducing the amount of the nitrogen penetrating gas in contact with the material, a control of lowering the atmosphere pressure, a control of raising the temperature of the denitrifying heat treatment, or a control of increasing the time of the denitrifying heat treatment.

### (Cooling Step)

The cooling step is a step of rapidly cooling the material to a martensite transformation temperature or less (Ms transformation point) for phase transformation to a body-centered tetragonal (bct) martensite structure. Rapid cooling can be performed by a treatment of cooling the material to lower than 100° C. using a coolant such as oil or water, or a subzero treatment of cooling the material to 0° C. or lower using a coolant such as dry ice or liquid nitrogen.

When the material having undergone the nitrogen penetration heat treatment is rapidly cooled, a magnetic material having a bct structure where nitrogen atoms are dissolved in the matrix can be obtained. In the nitrogen penetration heat treatment step, when the diffusion amount of nitrogen is reduced, nitrogen defects are introduced, and the magnetic material where the molar ratio of iron to nitrogen in the crystal having a bct structure exceeds 8 can be obtained. The magnetic material may include bcc phase where nitrogen is not dissolved, fcc phase of austenite or Fe₄N, or the like.

### (Carburizing Heat Treatment Step)

When a part of nitrogen in the body-centered tetragonal (bct) crystal into which nitrogen defects are introduced is substituted with carbon, a carburizing heat treatment step may also be performed before or after the nitrogen penetration heat treatment step.

When a part of nitrogen is substituted with carbon, the carburizing treatment can be performed using a method of performing a heat treatment on the material at a temperature higher than the eutectic temperature (A1 transformation point) and bringing the material into contact with a carbon source. After performing the carburizing treatment on the material, it is preferable that the material is cooled to about 200° C. to form a carbide. The carburizing treatment can be performed, for example, by gas carburizing. As carburizing gas, acetylene, methane, propane, butane, or the like can be used. The carburizing gas can be supplied continuously or intermittently in an inert gas atmosphere.

Next, after forming a carbide, it is preferable that the material is heated to about the eutectic temperature (A1 transformation point), is kept at the eutectic temperature, is rapidly heated to an austenite formation temperature (Ac3 transformation point) or higher, and is rapidly cooled. For example, the material in which the carbide has been generated is heated to 700° C. to 900° C., is kept at the same temperature, and is rapidly heated to 900° C. or higher. The heating speed of the rapid heating is preferably 100° C./sec or longer. It is preferable that the rapid heating is a treatment of keeping the material at about 950° C. for about 1 second.

As such, when the material is heated to about the eutectic temperature, the carbide can be dispersed in a phase having a lower solubility limit of carbon than γ phase. Next, when the material is rapidly heated, the carbide dispersed in the matrix is rapidly decomposed such that carbon atoms can be dissolved with high uniformity. Therefore, when the cooling step is performed after performing the carburizing heat treatment step, the magnetic material can be obtained where a part of nitrogen is substituted with carbon, nitrogen defects are introduced, and the molar ratio of iron to nitrogen in the crystals having a bct structure exceeds 8.

### <Soft Magnetic Steel Sheet>

The magnetic material according to the embodiment can be used in the form of a sheet-shaped or foil-shaped soft magnetic steel sheet. The soft magnetic steel sheet is a soft magnetic steel sheet formed of the magnetic material, and includes body-centered tetragonal (bct) crystal including iron and nitrogen into which nitrogen defects are introduced. As long as bct crystal including iron and nitrogen is included, the soft magnetic steel sheet may partially include one kind or more among α′ phase, γ phase, and γ′ phase of Fe₈N, ε phase of Fe₃N, and the like.

The soft magnetic steel sheet may include unavoidable impurities in addition to the metal elements such as iron (Fe), nitrogen (N), cobalt (Co), or nickel (Ni) and the light elements such as carbon (C), oxygen (O), or boron (B). Examples of the unavoidable impurities include hydrogen (H), silicon (Si), phosphorus (P), sulfur (S), chromium (Cr), manganese (Mn), and copper (Cu). The total content of such elements is preferably 3 at % or less.

The thickness of the soft magnetic steel sheet is, for example, 1 μm or more and 1 mm or less. The soft magnetic steel sheet can be obtained by performing hot rolling, cold rolling, or a combination thereof on the sheet-shaped or foil-shaped magnetic material. Between steps of a multi-stage rolling step, annealing can also be performed within ranges of temperature and time where nitrogen defects are not excessively formed. A tension annealing treatment of annealing the sheet-shaped or foil-shaped magnetic material while applying tensile stress thereto may be performed.

The soft magnetic steel sheet may have a configuration in which a concentration gradient of cobalt is formed and the magnetic material that includes body-centered tetragonal (bct) crystal including iron and nitrogen into which nitrogen defects are introduced is stacked. As long as the magnetic material is included, the stacked soft magnetic steel sheet may include a low carbon steel sheet, an electromagnetic pure iron sheet, an electromagnetic steel sheet, an iron-silicon alloy sheet, an iron-cobalt-based alloy sheet, or the like.

### <Iron Core and Rotating Electric Machine>

The soft magnetic steel sheet formed of the magnetic material according to the embodiment can be used as a material of an iron core. The iron core can be formed by punching and stacking the soft magnetic steel sheet. The iron core can be used for a stator of a rotating electric machine. As long as the iron core is formed of the magnetic material that includes body-centered tetragonal (bet) crystal including iron and nitrogen into which nitrogen defects are introduced, the iron core may be obtained by stacking a low carbon steel sheet, an electromagnetic pure iron sheet, an electromagnetic steel sheet, an iron-silicon alloy sheet, an iron-cobalt-based alloy sheet, or the like.

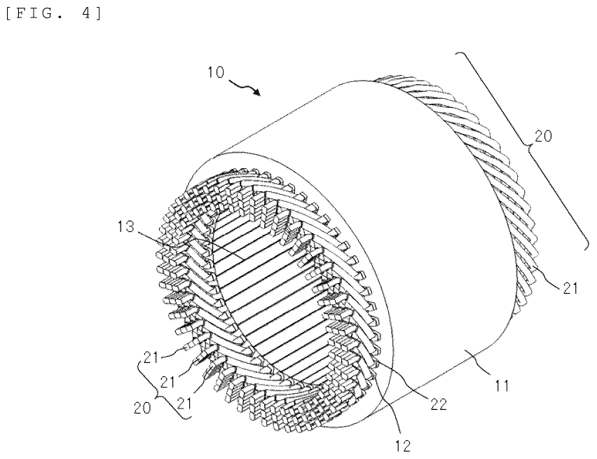

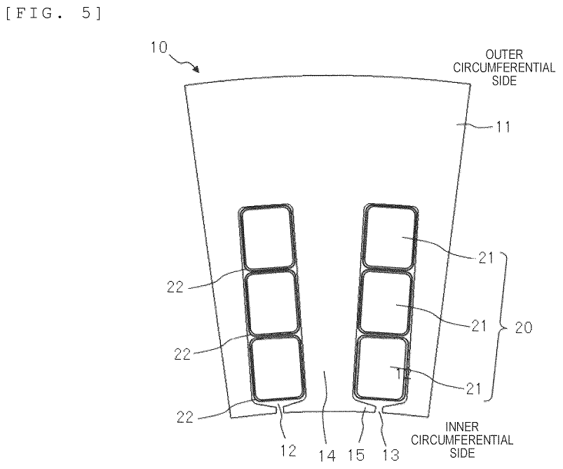

FIG. 4 is a perspective view schematically illustrating an example of the stator of the rotating electric machine. FIG. 5 is an enlarged cross-sectional view schematically illustrating a slot region of the stator. The cross-section refers to a cross-section orthogonal to a rotating axis direction (a cross-section of which the normal line is parallel to the rotating axis direction). In the rotating electric machine, a rotor (not illustrated) is disposed radially inside the stator illustrated in FIGS. 4 and 5.

As illustrated in FIGS. 4 and 5, in a stator 10, a stator coil 20 is wound around a plurality of stator slots 12 formed in an inner circumferential side of an iron core 11. The stator slots 12 are arranged and formed at predetermined pitches in a circumferential direction of the iron core 11, are spaces that penetrate and are formed in the axis direction, and include slits 13 that are formed as openings in the outermost circumferential portion to extend in the axis direction. Regions that divide the stator slots 12 adjacent to each other will be referred to as teeth 14 of the iron core 11. Portions that define the slits 13 in inner circumferential side tip regions of the teeth 14 will be referred to as teeth claw portions 15.

The stator coil 20 is typically formed of a plurality of segment conductors 21. For example, in FIGS. 4 and 5, the stator coil 20 is formed of three segment conductors 21 corresponding to U phase, V phase, and W phase of three-phase currents. From the viewpoint of preventing partial discharge between the segment conductors 21 and the iron core 11 and partial discharge between the respective phases (U phase, V phase, and W phase), typically, an outer circumference of each of the segment conductors 21 is covered with an electrical insulating material 22 (for example, insulating paper or enamel coating).

The iron core and the rotating electric machine formed of the soft magnetic steel sheet according to the embodiment are the iron core 11 formed by forming a plurality of the soft magnetic steel sheets according to the embodiment in a predetermined shape and stacking the soft magnetic steel sheets in an axis direction and the rotating electric machine where the iron core 11 is used. The soft magnetic steel sheet has magnetic characteristics such as a saturation magnetic flux density Bs higher than that of pure iron and a coercive force He lower than or equal to that of pure iron. Therefore, the iron core having a higher conversion efficiency between electric energy and magnetic energy than the iron core formed of an electromagnetic steel sheet in the related art can be provided. The high-efficiency iron core can implement a reduction in size and an increase in torque of the rotating electric machine.

The soft magnetic steel sheet according to the embodiment can adopt a low carbon steel sheet, an electromagnetic pure iron sheet, or the like having a lower material cost than an Fe—Co-based steel sheet, and thus also has an advantageous effect in that a high-efficiency iron core and rotating electric machine can be provided at a low cost.

The rotating electric machine using the iron core formed of the soft magnetic steel sheet according to the embodiment for the iron core includes the stator (core) 10, the stator coil 20, and a rotor. When the magnetic material that includes body-centered tetragonal (bct) crystal including iron and nitrogen into which nitrogen defects are introduced is used as materials of the teeth 14, the teeth claw portions 15, and a back yoke of the iron core 11, a high saturation magnetic flux density Bs can be obtained as compared to a case where α″-Fe₁₆N₂ of perfect crystal in the related art is used.

Hereinabove, the embodiment of the invention have been described, but the invention is not limited to the above-described embodiments. Within a range not departing from the scope of the invention, various changes can be made. For example, the invention does not necessarily include all the configurations in the embodiment. A part of configurations in one embodiment may be replaced by other configurations, a part of configurations in one embodiment may be added to another embodiment, or a part of configurations in one embodiment may be omitted.

### EXAMPLES

Hereinafter, the invention will be described in more detail using various examples. Note that the invention is not limited configurations and structures described in the examples.

### [Analysis 1]

A calculation model where one nitrogen atom was removed from a unit cell of α″-Fe₁₆N₂ was constructed, an electronic structure thereof was determined using a first principle density functional theory. A magnetic moment, a lattice constant, a unit cell volume, and a saturation magnetic flux density Bs were acquired.

As an exchange-correlation function, a generalized gradient approximation (GGA) was used. The cut-off energy in plane wave expansion of wave functions was 500 eV. The number of integration points in the Brillouin zone was 64 in total when each of axis directions was divided into four sections. Conditions where the energy can be evaluated with sufficiently high accuracy were adopted.

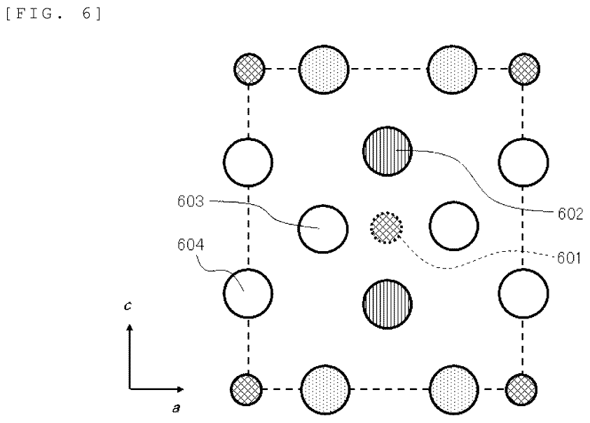

FIG. 6 is a diagram illustrating the calculation model used for calculating the electronic structure.

FIG. 6 illustrates a body-centered tetragonal (bct) calculation model used for calculating the electronic structure. In FIG. 6, reference numeral 601 represents atomic vacancy at a 2a site introduced as a nitrogen defect. Reference numeral 602 represents a 4e site. Reference numeral 603 represents an 8h site. Reference numeral 604 represents a 4d site.

As illustrated in FIG. 6, the atomic vacancy 601 was formed by removing a nitrogen atom positioned at the center of the unit cell of Fe₁₆N₂. When nitrogen defects are introduced, stable positions of iron atoms binding to the nitrogen atom change. The stable position of each of the atoms after the introduction of the nitrogen defect was obtained by calculating a force acting on each of the atoms, sequentially updating atomic coordinates, and determining the position based on energy stability. While updating the atomic coordinates, the lattice shape of the unit cell was optimized until the force acting on each of the atoms reached zero.

As a result of calculating the electronic structure of Fe₁₆N into which the nitrogen defects were introduced, the magnetic moment of the iron atom in the 4e site (602) released from the binding to the nitrogen atom was 2.51μ_{B}. When the nitrogen defects were not introduced, the magnetic moment was 2.18μ_{B}. Therefore, a magnetic moment of 0.33μ_{B} was added. When the nitrogen defects were introduced, the magnetic moment was improved by 15%, and the result supporting the idea of the inventors was obtained.

The magnetic moment of the iron atom in the 8h site (603) released from the binding to the nitrogen atom was 2.46μ_{B}. When the nitrogen defects were not introduced, the magnetic moment was 2.38μ_{B}. Therefore, a magnetic moment of 0.08μ_{B} was added. When the nitrogen defects were introduced, the magnetic moment was improved by 3%. Although the effect was lower than that of the 4e site (602), the action of improving the saturation magnetic flux density Bs was verified.

The magnetic moment of the iron atom in the 4d site (604) not binding to the nitrogen atom was 2.67μ_{B}. When the nitrogen defects were not introduced, the magnetic moment was 2.85μ_{B}. Therefore, a magnetic moment of 0.18μ_{B} was decreased. When the nitrogen defects were introduced, the magnetic moment was decreased by 6%.

The total magnetic moment in the unit cell of Fe₁₆N into which the nitrogen defects were introduced was 37.9μ_{B}. When the nitrogen defects were not introduced, the magnetic moment was 38.6μ_{B}. Therefore, a magnetic moment of 0.7μ_{B} was decreased. Note that, from the viewpoint of the practical use of the magnetic material, the saturation magnetic flux density Bs is more important than the magnetic moment of the unit cell. The magnetic flux per volume of the unit cell can be acquired by dividing the magnetic moment of the unit cell by the volume of the unit cell.

The volume of the unit cell of Fe₁₆N₂ into which the nitrogen defects were not introduced was 201.2 Å³. The saturation magnetic flux density Bs per volume of the unit cell of Fe₁₆N₂ was 2.23 T. On the other hand, the volume of the unit cell of Fe₁₆N into which the nitrogen defects were introduced was 193.3 Å³. The saturation magnetic flux density Bs per volume of the unit cell of Fe₁₆N was 2.28 T.

As described above, when the nitrogen defects were introduced, the magnetic moments of the 4e site and the 8h site was increased as desired, but the magnetic moment of the 4d site was decreased. When the nitrogen defects were introduced, the magnetic moment of the unit cell was decreased, but the volume of the unit cell was decreased. As a result, it was found that the magnetic flux density per volume of the unit cell was increased, and the high saturation magnetic flux density Bs was obtained.

### [Analysis 2]

A calculation model where one nitrogen atom was removed from a unit cell of Co₁₆N₂ was constructed, an electronic structure thereof was determined by first principle calculation using a density-functional theory, and a magnetic moment, a unit cell volume, and a saturation magnetic flux density Bs were acquired.

The analysis 2 is to verify that, even when iron atoms of Fe₁₆N₂ are substituted with another element, the effect of the introduction of nitrogen defects can be obtained. Using the same method as that of the analysis 1, a force acting on each of the atoms in the bct structure was calculated to derive an equilibrium state, and the calculation of the analysis 2 was performed on atomic coordinates or a lattice shape in the equilibrium state. The same calculation was performed on Co₁₆N₂ of perfect crystal into which nitrogen defect were not introduced.

The total magnetic moment in the unit cell of Co₁₆N₂ into which the nitrogen defects were not introduced was 23.0μ_{B}. The magnetic moment of cobalt was less than that of iron. Therefore, as expected, the total magnetic moment in the unit cell of Co₁₆N₂ was less than the total magnetic moment in the unit cell of Fe₁₆N₂.

On the other hand, the total magnetic moment in the unit cell of Co₁₆N into which the nitrogen defects were introduced was 24.4μ_{B}. When the nitrogen defects were not introduced, the magnetic moment was 23.0μ_{B}. Therefore, a magnetic moment of 1.4μ_{B} was added.

The volume of the unit cell of Co₁₆N₂ into which the nitrogen defects were not introduced was 187.1 Å³. The saturation magnetic flux density Bs per volume of the unit cell of Co₁₆N₂ was 1.43 T. On the other hand, the volume of the unit cell of Co₁₆N into which the nitrogen defects were introduced was 180.9 Å³. The saturation magnetic flux density Bs per volume of the unit cell of Co₁₆N was 1.57 T.

As described above, when the nitrogen defects were introduced, the volume of the unit cell was decreased by 6.2 Å³, which was 3% less than that when the nitrogen defects were not introduced. As a result, in Co₁₆N into which the nitrogen defect were introduced, a high saturation magnetic flux density Bs was obtained. It was verified that, even when iron atoms of Fe₁₆N₂ are substituted with another element, the effect of the introduction of nitrogen defects can be obtained.

### [Analysis 3]

A calculation model where one carbon atom was removed from a unit cell of Fe₁₆C₂ was constructed, an electronic structure thereof was determined by first principle calculation using a density-functional theory, and a magnetic moment, a unit cell volume, and a saturation magnetic flux density Bs were acquired.

The analysis 3 is to verify that, even when nitrogen atoms of Fe₁₆N₂ are substituted with another element, the effect of the introduction of light element defects can be obtained. Using the same method as that of the analysis 2, a force acting on each of the atoms in the bct structure was calculated to derive an equilibrium state, and the calculation of the analysis 3 was performed on atomic coordinates or a lattice shape in the equilibrium state. The same calculation was performed on Fe₁₆C₂ of perfect crystal into which light element defects were not introduced.

The total magnetic moment in the unit cell of Fe₁₆C₂ into which the light element defects were not introduced was 36.9μ_{B}. In Fe₁₆N₂, the magnetic moment was 38.6μ_{B}. Therefore, a magnetic moment of 1.7μ_{B} was decreased.

The total magnetic moment in the unit cell of Fe₁₆C into which the light element defects were introduced was 37.5μ_{B}. When the light element defects were not introduced, the magnetic moment was 36.9μ_{B}. Therefore, a magnetic moment of 0.6μ_{B} was added.

The volume of the unit cell of Fe₁₆C₂ into which the light element defects were not introduced was 200.3 Å³. The saturation magnetic flux density Bs per volume of the unit cell of Fe₁₆C₂ was 2.15 T. On the other hand, the volume of the unit cell of Fe₁₆C into which the light element defects were introduced was 193.1 Å³. The saturation magnetic flux density Bs per volume of the unit cell of Fe₁₆C was 2.26 T.

As described above, even when the light element defect was introduced, the high saturation magnetic flux density Bs was obtained as compared to perfect crystal. It was verified that, even when nitrogen atoms of Fe₁₆N₂ are substituted with another element, the effect of the introduction of light element defects can be obtained.

Table 1 shows the results of the magnetic moment, the lattice constant, the unit cell volume, and the saturation magnetic flux density Bs. The lattice constants of 9 types represented by Fe₁₆N₂₋ₓ where x=0, 0.25, 0.5, 0.75, 1.0, 1.25, 1.5, 1.75, and 2.0 are shown.

TABLE 1

| | | | | | | Saturation |
|---|---|---|---|---|---|---|
| | | Magnetic | a-Axis | c-Axis | | Magnetic |
| | | Moment | Length | Length | Volume | Flux Density |
| | Composition | [μ_{B}] | [Å] | [Å] | [Å³] | [T] |
| Analysis | Fe16NO | — | 5.66 | 5.66 | 181.3 | — |
| | Fe16N0.25 | — | 5.67 | 5.75 | 184.9 | — |
| | Fe16N0.5 | — | 5.67 | 5.83 | 187.4 | — |
| | Fe16N0.75 | 37.5 | 5.66 | 5.96 | 190.9 | — |
| | Fe16N1.0 | — | 5.65 | 6.06 | 193.5 | — |
| | Fe16N1.25 | — | 5.66 | 6.09 | 195.1 | — |
| | Fe16N1.5 | — | 5.67 | 6.12 | 196.8 | — |
| | Fe16N1.75 | — | 5.68 | 6.18 | 199.4 | — |
| Analysis 1 | Fe16N2 | 38.6 | 5.68 | 6.23 | 201.2 | 2.23 |
| | Fe16N | 37.9 | — | — | 193.3 | 2.28 |
| Analysis 2 | Co16N2 | 23.0 | — | — | 187.1 | 1.43 |
| | Co16N | 24.4 | — | — | 180.9 | 1.57 |
| Analysis 3 | Fe16C2 | 36.9 | — | — | 200.3 | 2.15 |
| | Fe16C | 37.5 | — | — | 193.1 | 2.26 |

As shown in the analyses 1 to 3, it was verified that, when nitrogen defects are introduced into α″-Fe₁₆N₂, a change in magnetic moment or a change in crystal volume occurs such that the saturation magnetic flux density Bs per volume of the unit cell is improved. It can be said that the magnetic material includes the bct crystal structure into which nitrogen defects are introduced such that a high saturation magnetic flux density Bs can be obtained as compared to α″-Fe₁₆N₂.

### REFERENCE SIGNS LIST

10: stator
11: iron core
12: stator slot
13: slit
14: teeth
15: teeth claw portion
20: stator coil
21: segment conductor
22: electrical insulating material
101: iron (4e site)
102: iron (8h site)
103: iron (4d site)
104: nitrogen (2a site)
201: iron (4e site)
202: iron (8h site)
203: iron (4d site)
204: nitrogen (2a site)
205: atomic vacancy
206: boundary between unit cells of crystal

1. A magnetic material comprising body-centered tetragonal (bct) crystal including iron and nitrogen, wherein a molar ratio of iron to nitrogen in the crystal exceeds 8.

2. The magnetic material according to claim 1, wherein
the molar ratio of iron to nitrogen in the crystal is 32 or less.

3. The magnetic material according to claim 1, wherein
a part or the entirety of iron in the crystal is substituted with cobalt.

4. The magnetic material according to claim 1, wherein
a part of nitrogen in the crystal is substituted with carbon.

5. The magnetic material according to claim 1, wherein
a lattice constant of a c-axis of the crystal is less than 6.23 Å.

6. The magnetic material according to claim 1, wherein
a volume of a unit lattice of the crystal is less than 201.2 Å³.

7. The magnetic material according to claim 1, wherein
a minimum distance between nitrogen atoms in the crystal is 6.8 Å or more.

8. The magnetic material according to claim 1, wherein
a nitrogen content is 2.8 at % or more and 8.3 at % or less.

9. The magnetic material according to claim 1, wherein
a cobalt content is 25 at % or less.

10. An iron core where soft magnetic steel sheets are stacked, wherein a part or the entirety of the soft magnetic steel sheets is formed of the magnetic material according to claim 1.

11. A rotating electric machine comprising an iron core where soft magnetic steel sheets are stacked, wherein a part or the entirety of the soft magnetic steel sheets is formed of the magnetic material according to claim 1.
